(19) United States
(12) Patent Application Publication
(10) Pub. No.: US 2017/0291171 A1
(43) Pub. Date: Oct. 12, 2017

(54) SUBSTANCE PURIFICATION DEVICE AND CARTRIDGE

(71) Applicant: Seiko Epson Corporation, Tokyo (JP)

(72) Inventors: Toshiro MURAYAMA, Fujimi-machi (JP); Fumio TAKAGI, Chino-shi (JP)

(21) Appl. No.: 15/513,903

(22) PCT Filed: Sep. 30, 2015
(86) PCT No.: PCT/JP2015/004977

§ 371 Date: Mar. 23, 2017

(30) Foreign Application Priority Data
Sep. 30, 2014 (JP) 2014-199562

(51) Int. Cl. B01L 3/00; G01N 35/00; B01L 7/00

(52) U.S. Cl. CPC B01L 3/502; B01L 7/52; B01L 7/525; G01N 35/0098; B01L 2200/028; B01L 2200/0621; B01L 2400/043; B01L 2300/0832

(57) ABSTRACT

A substance purification device ensures that the interface between an aqueous liquid layer and an oil-based liquid layer is maintained in a stable manner. The substance purification device includes a washing flow channel, and an elution flow channel that communicates with the washing flow channel, the washing flow channel including a first part, and a second part that is smaller than the first part as to the cross-sectional area in a plane that is orthogonal to the direction in which the washing flow channel extends, an interface between a washing liquid and a fluid that is immiscible with the washing liquid being situated within the second part, the elution flow channel including a third part, and a fourth part that is smaller than the third part as to the cross-sectional area in a plane that is orthogonal to the direction in which the elution flow channel extends, an interface between an eluent and a fluid that is immiscible with the eluent being situated within the fourth part, the washing liquid being a liquid with which a substance-binding solid-phase carrier on which a substance is adsorbed is washed, and the eluent being a liquid with which the substance is eluted from the substance-binding solid-phase carrier.

### CROSS REFERENCE TO RELATED APPLICATIONS

This application is a U.S. National Phase Application under 35 U.S.C. 371 of International Application No. PCT/JP2015/004977 filed on Sep. 30, 2015 and published in English as WO 2016/051794 A1 on Apr. 7, 2016. This application claims priority to Japanese Patent Application No. 2014-199562 filed on Sep. 30, 2014. The entire disclosures of all of the above applications are incorporated herein by reference.

### TECHNICAL FIELD

The present invention relates to a substance purification device and a cartridge.

### BACKGROUND ART

Polymerase chain reaction (PCR) technology has been established in the field of biochemistry. In recent years, PCR amplification accuracy and PCR detection sensitivity have been improved, and it has become possible to amplify, detect, and analyze a trace amount of a sample (e.g., DNA). PCR technology subjects a solution (reaction solution) that includes the amplification target nucleic acid (target nucleic acid) and a reagent to thermal cycling to amplify the target nucleic acid. The solution is normally subjected to PCR thermal cycling at two or three different temperatures.

At present, the presence or absence of infection (e.g., influenza) is normally determined using a rapid test kit (e.g., immunochromatography). However, since the determination accuracy may be insufficient when such a rapid test kit is used, it has been desired to use PCR technology that can achieve higher examination accuracy when determining the presence or absence of infection.

In recent years, a device in which aqueous liquid layers and water-insoluble gel layers are alternately stacked within a capillary has been proposed as a device used for PCR technology and the like (see WO2012/086243). In this case, a magnetic material particle to which a nucleic acid adheres is passed through the capillary to purify the nucleic acid.

### SUMMARY OF INVENTION

### Technical Problem

In the device disclosed in Patent Literature 1, the aqueous liquid layers and the water-insoluble gel layers are alternately stacked within the capillary having a constant cross-sectional area (e.g., a capillary that does not have a narrow part). Therefore, the area of the interface between the aqueous liquid layer and the water-insoluble gel layer increases when the size of the device is reduced by decreasing the length of the capillary while maintaining the volume of the aqueous liquid layer or the water-insoluble gel layer to be equal to or larger than a given volume, for example. As a result, the shape and the position of the interface may easily change, and the interface may become unstable.

An object of several aspects of the invention is to provide a substance purification device and a cartridge that ensure that the interface between an aqueous liquid layer and an oil-based liquid layer is maintained in a stable manner.

### Solution to Problem

The invention was conceived in order to solve at least some of the above problems, and may be implemented as described below (see the following aspects or application examples).

### APPLICATION EXAMPLE 1

According to one aspect of the invention, a substance purification device includes:

a washing flow channel; and

an elution flow channel that communicates with the washing flow channel,

the washing flow channel including a first part, and a second part that is smaller than the first part as to the cross-sectional area in a plane that is orthogonal to the direction in which the washing flow channel extends, an interface between a washing liquid and a fluid that is immiscible with the washing liquid being situated within the second part,

the elution flow channel including a third part, and a fourth part that is smaller than the third part as to the cross-sectional area in a plane that is orthogonal to the direction in which the elution flow channel extends, an interface between an eluent and a fluid that is immiscible with the eluent being situated within the fourth part, the washing liquid being a liquid with which a substance-binding solid-phase carrier on which a substance is adsorbed is washed, and

the eluent being a liquid with which the substance is eluted from the substance-binding solid-phase carrier.

The substance purification device is configured so that the interface between the washing liquid and the fluid that is immiscible with the washing liquid and the interface between the eluent and the fluid that is immiscible with the eluent are respectively situated within the second part and the fourth part having a small cross-sectional area. Therefore, the interface has a small area, and is rarely deformed or moved. This makes it possible to stably maintain the positions of the washing liquid, the eluent, and the fluids that are immiscible therewith in the direction in which the flow channel extends.

### APPLICATION EXAMPLE 2

In the substance purification device as defined in Application Example 1, the washing flow channel may include a plurality of the first parts and a plurality of the second parts, and the plurality of first parts and the plurality of second parts may be alternately provided in the direction in which the washing flow channel extends.

According to this configuration, since the washing flow channel includes a plurality of second parts, a plurality of washing liquids can be easily provided, for example. This makes it possible to easily wash the substance with the washing liquid two or more times, and more efficiently wash the substance.

### APPLICATION EXAMPLE 3

In the substance purification device as defined in Application Example 1 or 2, an interface between the washing liquid and the fluid that is immiscible with the washing liquid may be situated within the first part.

According to this configuration, the interface between the washing liquid and the fluid that is immiscible with the washing liquid is situated within the second part having a small cross-sectional area, and another interface between the washing liquid and the fluid that is immiscible with the washing liquid is situated within the first part having a large cross-sectional area. This makes it possible to stably maintain the position of the washing liquid in the direction in which the flow channel extends, and increase the volume of the washing liquid without increasing the length of the device in the direction in which the flow channel extends. This makes it possible to more efficiently wash the substance.

### APPLICATION EXAMPLE 4

According to another aspect of the invention, a cartridge includes:

the substance purification device as defined in any one of Application Examples 1 to 3; and

a reaction container that forms a reaction chamber that communicates with the

elution flow channel,

the substance being a nucleic acid, and

the reaction chamber holding a fluid that is immiscible with the eluent, a nucleic acid amplification reaction being effected within the reaction chamber.

Since the cartridge is configured so that the positions of the washing liquid, the eluent, and the fluids (oils) that are immiscible therewith in the direction in which the flow channel extends can be maintained in a stable manner, it is possible to easily purify the nucleic acid, and efficiently effect the nucleic acid amplification reaction while reducing time.

### APPLICATION EXAMPLE 5

According to another aspect of the invention, a substance purification device includes a first washing flow channel, and a second washing flow channel that communicates with the first washing flow channel,

the first washing flow channel including a first part, and a second part that is smaller than the first part as to a cross-sectional area in a plane that is orthogonal to a direction in which the first washing flow channel extends, an interface between a first washing liquid and a fluid that is immiscible with the first washing liquid being situated within the second part,

the second washing flow channel including a third part, and a fourth part that is smaller than the third part as to a cross-sectional area in a plane that is orthogonal to a direction in which the second washing flow channel extends, an interface between a second washing liquid and a fluid that is immiscible with the second washing liquid being situated within the fourth part, and

the first washing liquid and the second washing liquid being a liquid with which a substance-binding solid-phase carrier on which a substance is adsorbed is washed.

The substance purification device is configured so that the interface between the washing liquid and the fluid that is immiscible with the washing liquid is situated within the second part and the fourth part having a small cross-sectional area. Therefore, the interface has a small area, and is rarely deformed or moved. This makes it possible to stably maintain the positions of the washing liquid and the fluid that is immiscible with the washing liquid in the direction in which the flow channel extends.

### APPLICATION EXAMPLE 6

According to another aspect of the invention, a cartridge includes:

the substance purification device as defined in Application Example 5; and

a reaction container that forms a reaction chamber that communicates with the first washing flow channel or the second washing flow channel,

the substance being a nucleic acid, and

a nucleic acid amplification reaction being effected within the reaction chamber.

Since the cartridge is configured so that the position of each interface in the direction in which the flow channel extends can be maintained in a stable manner, it is possible to easily purify the nucleic acid, and efficiently effect the nucleic acid amplification reaction while reducing time.

### BRIEF DESCRIPTION OF DRAWINGS

FIG. 1 is a front view illustrating a container assembly 1 according to one embodiment of the invention.

FIG. 2 is a side view illustrating a container assembly 1 according to one embodiment of the invention.

FIG. 3 is a plan view illustrating a container assembly 1 according to one embodiment of the invention.

FIG. 4 is a perspective view illustrating a container assembly 1 according to one embodiment of the invention.

FIG. 5 is a cross-sectional view illustrating a container assembly 1 according to one embodiment of the invention taken along the line A-A in FIG. 3.

FIG. 6 is a cross-sectional view illustrating a container assembly 1 according to one embodiment of the invention taken along the line C-C in FIG. 3.

FIG. 7A is a schematic view illustrating a method for operating a container assembly 1 according to one embodiment of the invention.

FIG. 7B is a schematic view illustrating a method for operating a container assembly 1 according to one embodiment of the invention.

FIG. 8A is a schematic view illustrating a method for operating a container assembly 1 according to one embodiment of the invention.

FIG. 8B is a schematic view illustrating a method for operating a container assembly 1 according to one embodiment of the invention.

FIG. 9 is a schematic configuration diagram illustrating a PCR device 50.

FIG. 10 is a block diagram illustrating a PCR device 50.

FIG. 11 is a schematic view illustrating the arrangement of the contents of a flow channel 2 included in a container assembly 1 according to one embodiment of the invention.

### DESCRIPTION OF EMBODIMENTS

Several exemplary embodiments of the invention are described in detail below with reference to the drawings. The following exemplary embodiments illustrate examples of the invention. It should be understood that the invention is not limited to the following exemplary embodiments, but includes various modifications that can be practiced without departing from the scope of the invention. Note that all of the elements described below in connection with the exemplary embodiments should not necessarily be taken as essential elements of the invention.

According to one embodiment of the invention, a substance purification device includes a washing flow channel, and an elution flow channel that communicates with the washing flow channel, the washing flow channel including a first part, and a second part that is smaller than the first part as to the cross-sectional area in a plane that is orthogonal to the direction in which the washing flow channel extends, an interface between a washing liquid and a fluid that is immiscible with the washing liquid being situated within the second part, the elution flow channel including a third part, and a fourth part that is smaller than the third part as to the cross-sectional area in a plane that is orthogonal to the direction in which the elution flow channel extends, an interface between an eluent and a fluid that is immiscible with the eluent being situated within the fourth part, the washing liquid being a liquid with which a substance-binding solid-phase carrier on which a substance (biological substance) is adsorbed is washed, and the eluent being a liquid with which the substance is eluted from the substance-binding solid-phase carrier.

According to another embodiment of the invention, a substance purification device includes a first washing flow channel, and a second washing flow channel that communicates with the first washing flow channel, the first washing flow channel including a first part, and a second part that is smaller than the first part as to a cross-sectional area in a plane that is orthogonal to a direction in which the first washing flow channel extends, an interface between a first washing liquid and a fluid that is immiscible with the first washing liquid being situated within the second part, the second washing flow channel including a third part, and a fourth part that is smaller than the third part as to a cross-sectional area in a plane that is orthogonal to a direction in which the second washing flow channel extends, an interface between a second washing liquid and a fluid that is immiscible with the second washing liquid being situated within the fourth part, and the first washing liquid and the second washing liquid being a liquid with which a substance-binding solid-phase carrier on which a substance (biological substance) is adsorbed is washed.

Specifically, the substance purification device may include the washing flow channel and the elution flow channel, or may include a plurality of washing flow channels.

According to another embodiment of the invention, a cartridge (container assembly) includes the substance purification device, and a reaction container that forms a reaction chamber that communicates with the elution flow channel, the substance being a nucleic acid, and the reaction chamber holding a fluid that is immiscible with the eluent, a nucleic acid amplification reaction being effected within the reaction chamber.

Examples of the biological substance include a biopolymer such as a nucleic acid (DNA and RNA), a polypeptide, a protein, and a polysaccharide, a biological low-molecular-weight organic compound such as a protein, an enzyme, a peptide, a nucleotide, an amino acid, and a vitamin, an inorganic compound, and the like. The embodiments of the invention will be described taking an example in which the biological substance is a nucleic acid.

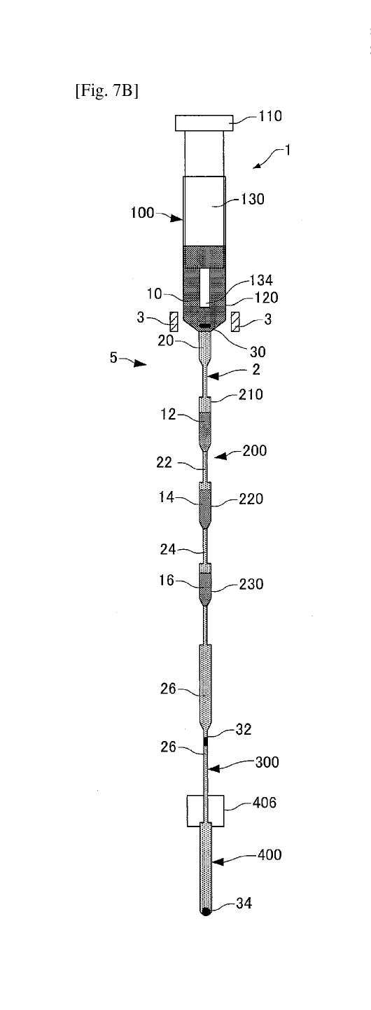

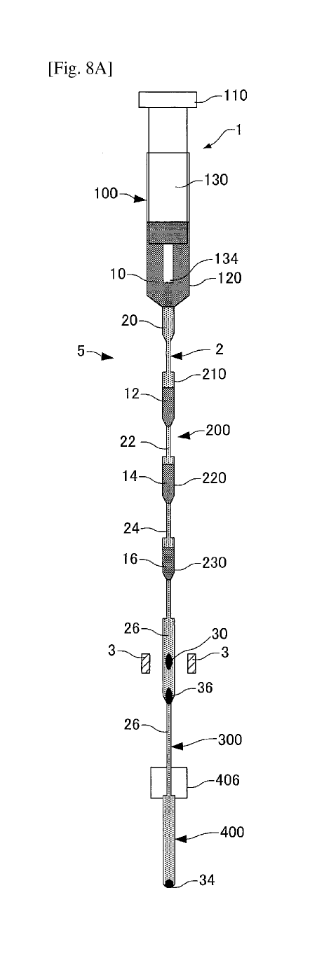

The term “substance-binding solid-phase carrier” used herein refers to a substance that can hold the biological substance through adsorption (i.e., reversible physical binding). It is preferable that the substance-binding solid-phase carrier be microparticles. Note that the substance-binding solid-phase carrier is not limited thereto. For example, the substance-binding solid-phase carrier may be microfibers or a net-like carrier. It is preferable that the substance-binding solid-phase carrier have magnetic properties so that the substance-binding solid-phase carrier can be moved in the desired direction within the container assembly in a state in which the biological substance is adsorbed on the substance-binding solid-phase carrier. The embodiments of the invention will be described taking an example in which the substance-binding solid-phase carrier is a magnetic bead 30 (see FIGS. 7A, 7B, 8A, and 8B) on which a nucleic acid is adsorbed.

The washing liquid 12, 14, 16 (see FIGS. 7A, 7B, 8A, and 8B) is a liquid for washing the substance-binding solid-phase carrier on which the biological substance is adsorbed. It is possible to remove impurities and the like while ensuring that the biological substance is adsorbed on the substance-binding solid-phase carrier in a stable manner by washing the substance-binding solid-phase carrier with the washing liquid.

The fluid that is immiscible with the washing liquid is a fluid that is immiscible with the washing liquid within the washing container, and undergoes phase separation with respect to the washing liquid. The fluid that is immiscible with the washing liquid is a substance that is inert to the washing liquid, and may be a gas such as air. When the washing liquid is an aqueous liquid, an oil, an oil gel, or the like that is immiscible with the aqueous liquid may be used as the fluid that is immiscible with the washing liquid. The term “oil gel” used herein refers to a gel that is obtained by subjecting a liquid oil to gelation using a gellant. Note that the term “oil” used herein excludes an oil gel. The embodiments of the invention will be described taking an example in which the fluid that is immiscible with the washing liquid is an oil 20, 22, 24, 26 (see FIGS. 7A, 7B, 8A, and 8B).

The eluent 32 (see FIGS. 7A, 7B, 8A, and 8B) is a substance with which the biological substance is desorbed and eluted from the substance-binding solid-phase carrier. For example, water or a buffer may be used as the eluent.

The fluid that is immiscible with the eluent is a fluid that is immiscible with the eluent within the elution container, and undergoes phase separation with respect to the eluent. The fluid that is immiscible with the eluent is a substance that is inert to the eluent. The embodiments of the invention will be described taking an example in which the fluid that is immiscible with the eluent is an oil 26 (see FIGS. 7A, 7B, 8A, and 8B).

### 1. Outline of Container Assembly

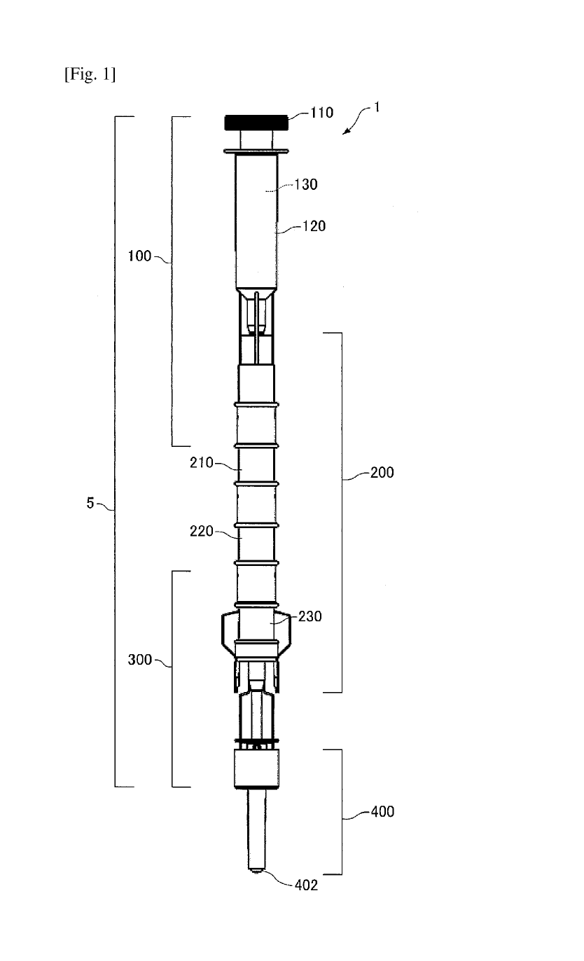

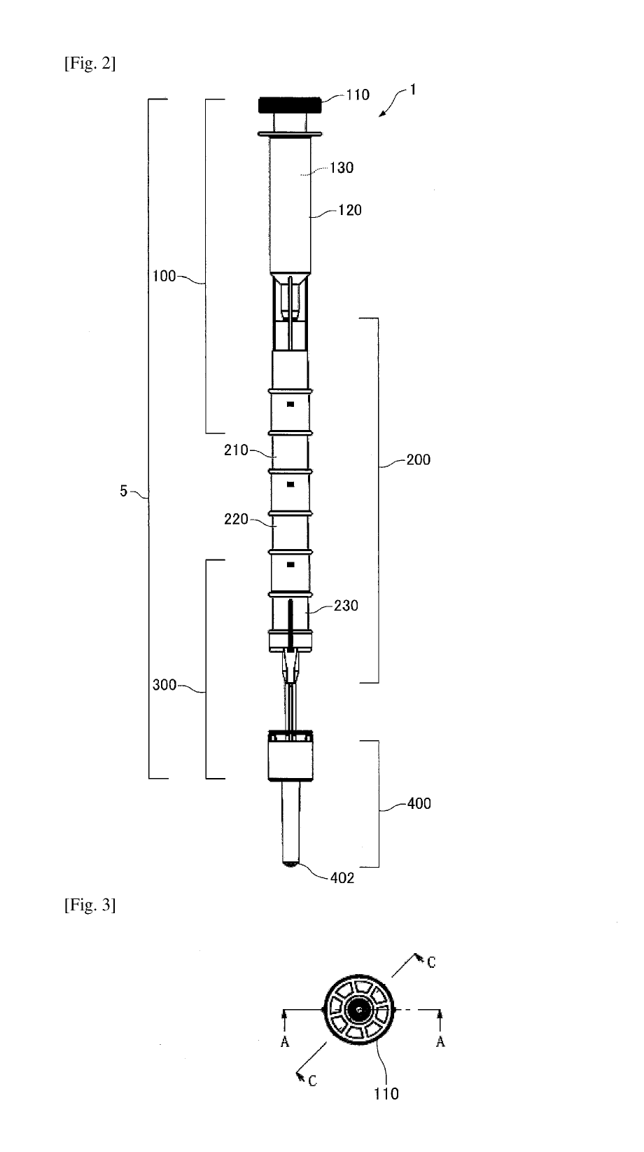

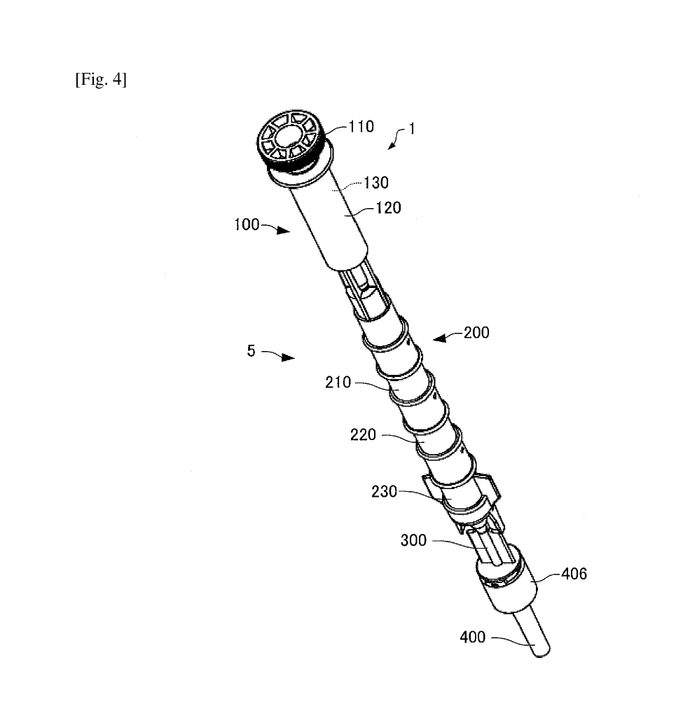

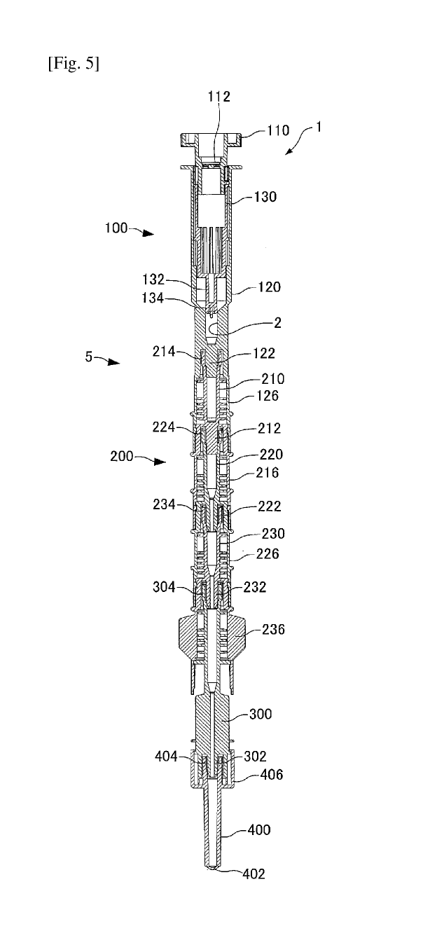

An outline of a container assembly 1 according to one embodiment of the invention is described below with reference to FIGS. 1 to 4. FIG. 1 is a front view illustrating the container assembly 1 (hereinafter may be referred to as “cartridge”) according to one embodiment of the invention. FIG. 2 is a side view illustrating the container assembly 1 according to one embodiment of the invention. FIG. 3 is a plan view illustrating the container assembly 1 according to one embodiment of the invention. FIG. 4 is a perspective view illustrating the container assembly 1 according to one embodiment of the invention. Note that the state of the container assembly 1 illustrated in FIGS. 1 to 3 is referred to as “upright state”.

The container assembly 1 includes an adsorption container 100, a washing container 200, an elution container 300, and a reaction container 400. The container assembly 1 is a container that forms a flow channel (not illustrated in the drawings) that extends (communicates) from the adsorption container 100 to the reaction container 400. The flow channel formed by the container assembly 1 is closed by a cap 110 at one end, and is closed by a bottom 402 at the other end.

The container assembly 1 is designed to effect a pretreatment that causes a nucleic acid to be bound to a magnetic bead (not illustrated in the drawings) within the adsorption container 100, purified while the magnetic bead moves within the washing container 200, and eluted into an eluent droplet (not illustrated in the drawings) within the elution container 300, and subjects the eluent droplet that includes the nucleic acid to PCR thermal cycling within the reaction container 400.

A material for forming the container assembly 1 is not particularly limited. For example, the container assembly 1 may be formed of glass, a polymer, a metal, or the like. It is preferable to form the container assembly 1 using a material (e.g., glass or polymer) that allows visible light to pass through since the inside (cavity) of the container assembly 1 can be observed from the outside. It is preferable to form the container assembly 1 using a material that allows a magnetic force to pass through or a non-magnetic material since the magnetic bead (not illustrated in the drawings) can be easily passed through the container assembly 1 by applying a magnetic force from the outside of the container assembly 1, for example. The container assembly 1 may be formed of a polypropylene resin, for example.

The adsorption container 100 includes a cylindrical syringe section 120 that holds an adsorbent (not illustrated in the drawings), a plunger section 130 that is a movable plunger that is inserted into the syringe section 120, and the cap 110 that is secured on one end of the plunger section 130. The adsorption container 100 is designed so that the plunger section 130 can be slid along the inner surface of the syringe section 120, and the adsorbent (not illustrated in the drawings) contained in the syringe section 120 can be discharged into the washing container 200 by moving the cap 110 toward the syringe section 120. The details of the adsorbent are described later.

The washing container 200 is assembled by joining a first washing container 210, a second washing container 220, and a third washing container 230. Each of the first washing container 210, the second washing container 220, and the third washing container 230 includes one or more washing liquid layers that are partitioned by an oil layer (not illustrated in the drawings). The washing container 200 (assembled by joining the first washing container 210, the second washing container 220, and the third washing container 230) includes a plurality of washing liquid layers that are partitioned by a plurality of oil layers (not illustrated in the drawings). Although an example in which the washing container 200 utilizes the first washing container 210, the second washing container 220, and the third washing container 230 has been described above, the number of washing containers may be appropriately increased or decreased corresponding to the number of washing liquid layers. The details of the washing liquid are described later.

The elution container 300 is joined to the third washing container 230 included in the washing container 200, and holds the eluent so that the shape of a plug can be maintained. The term “plug” used herein refers to a specific liquid when the specific liquid occupies a space (compartment) within a flow channel. More specifically, the plug of a specific liquid refers to a pillar-shaped space that is substantially occupied by only the specific liquid (i.e., the space within the flow channel is partitioned by the plug of the liquid). The expression “substantially” used in connection with the plug means that a small amount (e.g., thin film) of another substance (e.g., liquid) may be present around the plug (i.e., on the inner wall of the flow channel). The details of the eluent are described later.

A nucleic acid purification device 5 includes the adsorption container 100, the washing container 200, and the elution container 300.

The reaction container 400 is joined to the elution container 300, and receives a liquid discharged from the elution container 300. The reaction container 400 holds the eluent droplet that includes a sample during thermal cycling. The reaction container 400 also holds a reagent (not illustrated in the drawings). The details of the reagent are described later.

### 2. Details of Structure of Container Assembly

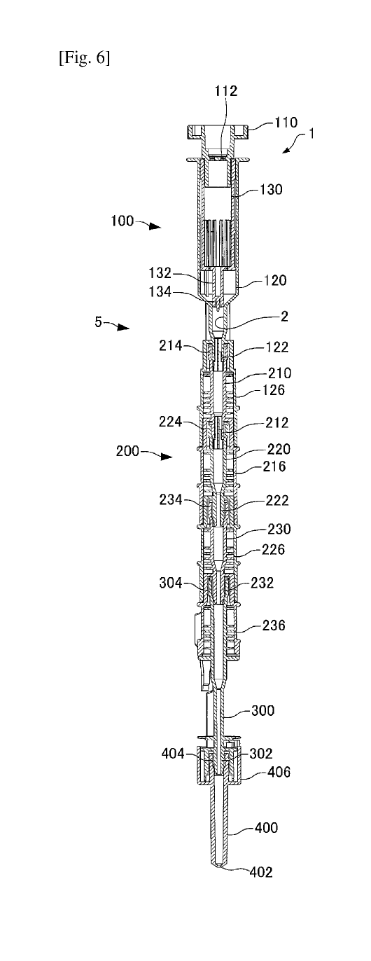

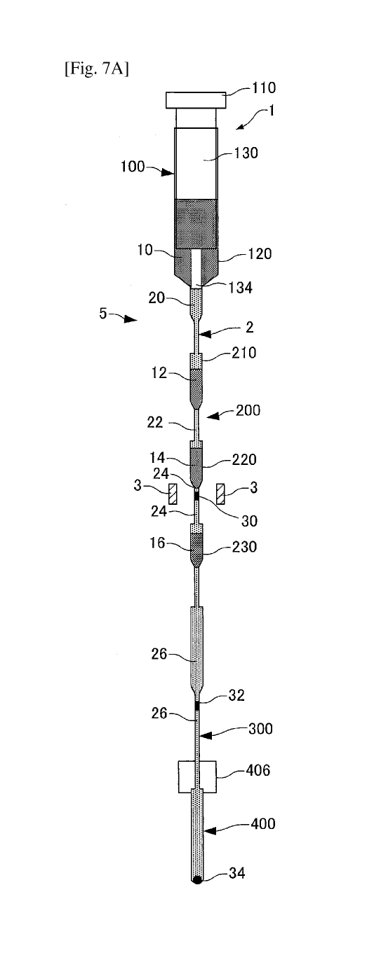

The details of the structure of the container assembly 1 are described below with reference to FIGS. 5 and 6. FIG. 5 is a cross-sectional view of the container assembly 1 according to one embodiment of the invention taken along the line A-A in FIG. 3. FIG. 6 is a cross-sectional view of the container assembly 1 according to one embodiment of the invention taken along the line C-C in FIG. 3. Note that the container assembly 1 is assembled in a state in which each container is charged with the washing liquid or the like. In FIGS. 5 and 6, the washing liquid and the like are omitted so that the structure of the container assembly 1 can be easily understood.

### 2-1. Adsorption Container

The adsorption container 100 has a structure in which the plunger section 130 is inserted into the syringe section 120 through one open end of the syringe section 120, and the cap 110 is inserted into the open end of the plunger section 130. The cap 110 has a vent section 112 that is provided at the center thereof. The vent section 112 suppresses a change in the internal pressure of the plunger section 130 when the plunger section 130 is operated.

The plunger section 130 is an approximately cylindrical plunger that slides along the inner circumferential surface of the syringe section 120. The plunger section 130 includes the open end into which the cap 110 is inserted, a rod-like section 132 that extends from the bottom situated opposite to the open end in the longitudinal direction of the syringe section 120, and an end section 134 that is provided at the end of the rod-like section 132. The rod-like section 132 protrudes from the center of the bottom of the plunger section 130. A through-hole is formed in the wall of the rod-like section 132 so that the inner space of the plunger section 130 communicates with the inner space of the syringe section 120.

The syringe section 120 forms part of a flow channel 2 of the container assembly 1. The syringe section 120 includes a large-diameter section that holds the plunger section 130, a small-diameter section that is smaller in inner diameter than the large-diameter section, a diameter reduction section that is provided between the large-diameter section and the small-diameter section and decreases in inner diameter, an adsorption insertion section 122 that is provided at the end of the small-diameter section, and a cylindrical adsorption cover section 126 that covers the adsorption insertion section 122. The large-diameter section, the small-diameter section, and the adsorption insertion section 122 that form part of the flow channel 2 of the container assembly 1 have an approximately cylindrical shape.

The end section 134 of the plunger section 130 seals the small-diameter section of the syringe section 120 (when the container assembly 1 is provided to the worker) to divide the large-diameter section and the diameter reduction section from the small-diameter section (i.e., divide the syringe section 120 into two compartments).

The adsorption insertion section 122 of the syringe section 120 is inserted and fitted into a first reception section 214 that forms one open end of the first washing container 210 included in the washing container 200 to join the syringe section 120 and the first washing container 210. The outer circumferential surface of the adsorption insertion section 122 comes in close contact with the inner circumferential surface of the first reception section 214 to prevent leakage of a liquid to the outside.

### 2-2. Washing Container

The washing container 200 forms part of the flow channel 2 of the container assembly 1, and includes the first washing container 210, the second washing container 220, and the third washing container 230 (i.e., is assembled by joining the first washing container 210, the second washing container 220, and the third washing container 230). The first washing container 210, the second washing container 220, and the third washing container 230 have an identical basic structure. Therefore, only the structure of the first washing container 210 is described below, and description of the structure of the second washing container 220 and the structure of the third washing container 230 is omitted.

The first washing container 210 has an approximately cylindrical shape, and extends in the longitudinal direction of the container assembly 1. The first washing container 210 includes a first insertion section 212 that is formed at one open end, the first reception section 214 that is formed at the other open end, and a cylindrical first cover section 216 that covers the first insertion section 212.

The outer diameter of the first insertion section 212 is approximately the same as the inner diameter of a second reception section 224. The inner diameter of the first reception section 214 is approximately the same as the outer diameter of the adsorption insertion section 122.

When the first insertion section 212 of the first washing container 210 is inserted and fitted into the second reception section 224 of the second washing container 220, the outer circumferential surface of the first insertion section 212 comes in close contact with (i.e., seals) the inner circumferential surface of the second reception section 224, and the first washing container 210 is joined to the second washing container 220. The first washing container 210, the second washing container 220, and the third washing container 230 are thus joined (connected) to form the washing container 200. The term “seal” used herein refers to sealing a container or the like so that at least a liquid or gas contained in the container or the like does not leak to the outside. The term “seal” used herein may include sealing a container or the like so that a liquid or gas does not enter the container or the like from the outside.

### 2-3. Elution Container

The elution container 300 has an approximately cylindrical shape, and extends in the longitudinal direction of the container assembly 1. The elution container 300 forms part of the flow channel 2 of the container assembly 1. The elution container 300 includes an elution insertion section 302 that is formed at one open end, and an elution reception section 304 that is formed at the other open end.

The inner diameter of the elution reception section 304 is approximately the same as the outer diameter of a third insertion section 232 of the third washing container 230. When the third insertion section 232 is inserted and fitted into the elution reception section 304, the outer circumferential surface of the third insertion section 232 comes in close contact with (i.e., seals) the inner circumferential surface of the elution reception section 304, and the third washing container 230 is joined to the elution container 300.

### 2-4. Reaction Container

The reaction container 400 has an approximately cylindrical shape, and extends in the longitudinal direction of the container assembly 1. The reaction container 400 forms part of the flow channel 2 of the container assembly 1. The reaction container 400 includes a reaction reception section 404 that is formed at the open end, a bottom 402 that is formed at the closed end (that is situated opposite to the open end), and a reservoir section 406 that covers the reaction reception section 404.

The inner diameter of the reaction reception section 404 is approximately the same as the outer diameter of the elution insertion section 302 of the elution container 300. When the elution insertion section 302 is inserted and fitted into the reaction reception section 404, the elution container 300 is joined to the reaction container 400.

The reservoir section 406 has a predetermined space, and is provided around the reaction reception section 404. The reservoir section 406 has a capacity sufficient to receive a liquid that overflows the reaction container 400 due to the movement of the plunger section 130.

### 3. Contents of Container Assembly, and Method for Operating Container Assembly

The contents of the container assembly 1 are described below with reference to FIG. 7A, and a method for operating the container assembly 1 is described below with reference to FIGS. 7A, 7B, 8A, and 8B. FIGS. 7A and 7B are schematic views illustrating the method for operating the container assembly 1 according to one embodiment of the invention. FIGS. 8A and 8B are schematic views illustrating the method for operating the container assembly 1 according to one embodiment of the invention. In FIGS. 7A, 7B, 8A, and 8B, each container is represented by the flow channel 2, and the external shape and the joint (junction) structure of each container are omitted so that the state of the contents can be easily understood.

### 3-1. Contents

FIG. 7A illustrates the state of the contents of the flow channel 2 when the container assembly 1 is set to the state illustrated in FIG. 1. An adsorbent 10, a first oil 20, a first washing liquid 12, a second oil 22, a second washing liquid 14, a third oil 24, a magnetic bead 30, the third oil 24, a third washing liquid 16, a fourth oil 26, an eluent 32, the fourth oil 26, and a reagent 34 are included in the flow channel 2 sequentially from the cap 110 to the reaction container 400.

The flow channel 2 has a structure in which parts (i.e., thick parts) having a large cross-sectional area (in a plane that is orthogonal to the longitudinal direction of the container assembly 1) and parts (i.e., thin parts) having a small cross-sectional area (in a plane that is orthogonal to the longitudinal direction of the container assembly 1) are provided alternately. The thin parts of the flow channel 2 respectively hold part or the entirety of the first oil 20, the second oil 22, the third oil 24, the fourth oil 26, and the eluent 32. The thin parts of the flow channel 2 have a cross-sectional area that ensures that the interface between liquids (may be fluids (hereinafter the same)) that are contiguous to each other and are immiscible with each other can be maintained within the thin part in a stable manner. Therefore, the relationship between a liquid situated within the thin part of the flow channel 2 and another liquid that is contiguous thereto can be maintained in a stable manner due to the liquid situated within the thin part. Even when the interface between a liquid situated within the thin part of the flow channel 2 and another liquid situated within the thick part of the flow channel 2 is formed within the thick part of the flow channel 2, the interface is formed at a predetermined position in a stable manner even if the interface is affected by a high impact by allowing the liquids to stand.

The thin part of the flow channel 2 is formed within the adsorption insertion section 122, the first insertion section 212, the second insertion section 222, the third insertion section 232, and the elution insertion section 302. In the elution container 300, the thin part of the flow channel 2 extends upward beyond the elution insertion section 302. Note that a liquid held within the thin part of the flow channel 2 is maintained in a stable manner even prior to assembly.

### 3-1-1. Oil

The first oil 20, the second oil 22, the third oil 24, and the fourth oil 26 include an oil, and are present in the form of a plug between the liquids contiguous thereto in the state illustrated in FIGS. 7A and 7B. A liquid that undergoes phase separation with respect to each oil (i.e., a liquid that is immiscible with each oil) is selected as the liquid contiguous to each oil so that the first oil 20, the second oil 22, the third oil 24, and the fourth oil 26 are present in the form of a plug. The first oil 20, the second oil 22, the third oil 24, and the fourth oil 26 may differ in the type of oil. An oil selected from a silicone-based oil (e.g., dimethyl silicone oil), a paraffinic oil, a mineral oil, and a mixture thereof may be used as the first oil 20, the second oil 22, the third oil 24, and the fourth oil 26, for example.

### 3-1-2. Adsorbent

The adsorbent 10 is a liquid in which the nucleic acid is adsorbed on the magnetic bead 30. For example, the adsorbent 10 is an aqueous solution that includes a chaotropic substance (material). 5 M guanidine thiocyanate, 2% Triton X-100, or 50 mM Tris-HCl (pH: 7.2) may be used as the adsorbent 10, for example. The adsorbent 10 is not particularly limited as long as the adsorbent 10 includes a chaotropic substance. A surfactant may be added to the adsorbent 10 in order to destroy a cell membrane, or denature proteins included in a cell. The surfactant is not particularly limited as long as the surfactant is normally used for extraction of a nucleic acid from a cell or the like. Specific examples of the surfactant include a nonionic surfactant such as a Triton-based surfactant (e.g., Triton-X) and a Tween-based surfactant (e.g., Tween 20), and an anionic surfactant such as sodium N-lauroyl sarcosinate (SDS). It is preferable to use a nonionic surfactant at a concentration of 0.1 to 2%. It is preferable that the adsorbent 10 include a reducing agent such as 2-mercaptoethanol or dithiothreitol. The solvent may be a buffer. It is preferable that the solvent have a pH of 6 to 8 (i.e., neutral region). It is preferable that the adsorbent 10 include a guanidine salt (3 to 7 M), a nonionic surfactant (0 to 5%), EDTA (0 to 0.2 mM), a reducing agent (0 to 0.2 M), and the like taking the above points into consideration.

The chaotropic substance is not particularly limited as long as the chaotropic substance produces chaotropic ions (i.e., monovalent anions having a large ionic radius) in an aqueous solution to increase the water solubility of hydrophobic molecules, and contributes to adsorption of the nucleic acid on the solid-phase carrier. Specific examples of the chaotropic substance include guanidine hydrochloride, sodium iodide, sodium perchlorate, and the like. It is preferable to use guanidine thiocyanate or guanidine hydrochloride that exhibits a high protein denaturation effect. These chaotropic substances are used at a different concentration. For example, guanidine thiocyanate is preferably used at a concentration of 3 to 5.5 M, and guanidine hydrochloride is preferably used at a concentration of 5 M or more.

When the chaotropic substance is present in the aqueous solution, the nucleic acid included in the aqueous solution is adsorbed on the surface of the magnetic bead 30 since it is thermodynamically advantageous for the nucleic acid to be adsorbed on a solid rather than being enclosed by water molecules.

3-1-3. Washing liquid

The first washing liquid 12, the second washing liquid 14, and the third washing liquid 16 are used to wash the magnetic bead 30 on which the nucleic acid is adsorbed.

The first washing liquid 12 is a liquid that undergoes phase separation with respect to the first oil 20 and the second oil 22. It is preferable that the first washing liquid 12 be water or an aqueous solution having a low salt concentration. When using an aqueous solution having a low salt concentration as the first washing liquid 12, a buffer is preferably used as the first washing liquid 12. The salt concentration in the aqueous solution having a low salt concentration is preferably 100 mM or less, more preferably 50 mM or less, and most preferably 10 mM or less. The first washing liquid 12 may include a surfactant (see above). The pH of the first washing liquid 12 is not particularly limited. The salt that may be used for the first washing liquid 12 (buffer) is not particularly limited. It is preferable to use Tris, HEPES, PIPES, phosphoric acid, or the like. It is preferable that the first washing liquid 12 include an alcohol in such an amount that adsorption of the nucleic acid on the carrier, a reverse transcription reaction, PCR, and the like are not hindered. In this case, the alcohol concentration in the first washing liquid 12 is not particularly limited.

The first washing liquid 12 may include a chaotropic substance. For example, when the first washing liquid 12 includes guanidine hydrochloride, the magnetic bead 30 or the like can be washed while maintaining or strengthening adsorption of the nucleic acid on the magnetic bead 30 or the like.

The second washing liquid 14 is a liquid that undergoes phase separation with respect to the second oil 22 and the third oil 24. The second washing liquid 14 may have the same composition as that of the first washing liquid 12, or may have a composition differing from that of the first washing liquid 12. It is preferable that the second washing liquid 14 be a solution that substantially does not include a chaotropic substance. This is because it is preferable to prevent a situation in which a chaotropic substance is incorporated in the subsequent solution. For example, a 5 mM Tris-HCl buffer may be used as the second washing liquid 14. It is preferable that the second washing liquid 14 include an alcohol (see above).

The third washing liquid 16 is a liquid that undergoes phase separation with respect to the third oil 24 and the fourth oil 26. The third washing liquid 16 may have the same composition as that of the second washing liquid 14, or may have a composition differing from that of the second washing liquid 14. Note that the third washing liquid 16 does not include an alcohol. The third washing liquid 16 may include citric acid in order to prevent a situation in which an alcohol enters the reaction container 400.

3-1-4. Magnetic bead

The magnetic bead 30 is a bead on which the nucleic acid is adsorbed. It is preferable that the magnetic bead 30 have relatively high magnetic properties so that the magnetic bead 30 can be moved using a magnet 3 that is provided outside the container assembly 1. The magnetic bead 30 may be a silica bead or a silica-coated bead, for example. The magnetic bead 30 may preferably be a silica-coated bead.

### 3-1-5. Eluent

The eluent 32 is a liquid that undergoes phase separation with respect to the fourth oil 26. The eluent 32 is present in the form of a plug that is situated between the fourth oil 26 within the flow channel 2 included in the elution container 300. The eluent 32 is a liquid with which the nucleic acid adsorbed on the magnetic bead 30 is eluted from the magnetic bead 30. The eluent 32 forms a droplet within the fourth oil 26 due to heating. For example, purified water may be used as the eluent 32. Note that the term “droplet” used herein refers to a liquid that is enclosed by a free surface.

### 3-1-6. Reagent

The reagent 34 includes a component necessary for a reaction. When effecting PCR within the reaction container 400, the reagent 34 may include at least one of an enzyme (e.g., DNA polymerase) and a primer (nucleic acid) for amplifying the target nucleic acid (DNA) eluted into the eluent droplet 36 (see FIGS. 8A and 8B), and a fluorescent probe for detecting the amplified product. For example, the reagent 34 includes all of the primer, the enzyme, and the fluorescent probe. The reagent 34 is incompatible with the fourth oil 26. The reagent 34 is dissolved upon contact with the droplet 36 of the eluent 32 including the nucleic acid, and undergoes a reaction. The reagent 34 is present in a solid state in the lowermost part of the flow channel 2 (within the reaction container 400) in the gravitational direction. For example, a freeze-dried reagent may be used as the reagent 34.

### 3-2. Method for Operating Container Assembly

An example of the method for operating the container assembly 1 is described below with reference to FIGS. 7A, 7B, 8A, and 8B.

The method for operating the container assembly 1 includes (A) joining the adsorption container 100, the washing container 200, the elution container 300, and the reaction container 400 to assemble the container assembly 1 (hereinafter may be referred to as “step (A)”), (B) introducing a sample that includes the nucleic acid into the adsorption container 100 that holds the adsorbent 10 (hereinafter may be referred to as “step (B)”), (C) moving the magnetic bead 30 from the second washing container 220 to the adsorption container 100 (hereinafter may be referred to as “step (C)”), (D) causing the nucleic acid to be adsorbed on the magnetic bead 30 by shaking the adsorption container 100 (hereinafter may be referred to as “step (D)”), (E) moving the magnetic bead 30 on which the nucleic acid is adsorbed from the adsorption container 100 to the elution container 300 sequentially through the first oil 20, the first washing liquid 12, the second oil 22, the second washing liquid 14, the third oil 24, the third washing liquid 16, and the fourth oil 26 (hereinafter may be referred to as “step (E)”), (F) eluting the nucleic acid adsorbed on the magnetic bead 30 into the eluent 32 within the elution container 300 (hereinafter may be referred to as “step (F)”), and (G) bringing the droplet that includes the nucleic acid into contact with the reagent 34 included in the reaction container 400 (hereinafter may be referred to as “step (G)”).

Each step is described below.

### Step (A) That Assembles Container Assembly 1

In the step (A), the adsorption container 100, the washing container 200, the elution container 300, and the reaction container 400 are joined to assemble the container assembly 1 so that the flow channel 2 is formed to extend from the adsorption container 100 to the reaction container 400 (see FIG. 7A). Although FIG. 7A illustrates a state in which the cap 110 is fitted to the adsorption container 100, the cap 110 is fitted to the plunger section 130 after the step (B).

More specifically, the elution insertion section 302 of the elution container 300 is inserted into the reaction reception section 404 of the reaction container 400, the third insertion section 232 of the third washing container 230 is inserted into the elution reception section 304 of the elution container 300, the second insertion section 222 of the second washing container 220 is inserted into the third reception section 234 of the third washing container 230, the first insertion section 212 of the first washing container 210 is inserted into the second reception section 224 of the second washing container 220, and the adsorption insertion section 122 of the adsorption container 100 is inserted into the first reception section 214 of the first washing container 210.

### Step (B) That Introduces Sample

In the step (B), a cotton swab that holds the sample is put into the adsorbent 10 through the opening of the adsorption container 100 into which the cap 110 is fitted, and immersed in the adsorbent 10, for example. More specifically, the cotton swab is inserted into the adsorption container 100 through the opening formed at one end of the plunger section 130 that is inserted into the syringe section 120. After removing the cotton swab from the adsorption container 100, the cap 110 is fitted into the adsorption container 100 (see FIG. 7A). The sample may be introduced into the adsorption container 100 using a pipette or the like. When the sample is in the form of a paste or a solid, the sample may be put into the adsorption container 100 (or caused to adhere to the inner wall of the plunger section 130) using a spoon, tweezers, or the like. As illustrated in FIG. 7A, the syringe section 120 and the plunger section 130 are not completely filled with the adsorbent 10, and an empty space is formed on the side of the opening into which the cap 110 is fitted.

The sample includes the nucleic acid that is the target (hereinafter may be referred to as “target nucleic acid”). The target nucleic acid is either or both of deoxyribonucleic acid (DNA) and ribonucleic acid (RNA), for example. The target nucleic acid is extracted from the sample, eluted into the eluent 32 (described later), and used as a PCR template, for example. Examples of the sample include a biological sample such as blood, nasal mucus, and an oral mucous membrane, and the like.

### Step (C) That Moves Magnetic Bead

In the step (C), the magnetic bead 30 that is situated between the third oil 24 and present in the form of a plug within the second washing container 220 is moved by moving the magnet 3 (that is disposed outside the container) toward the adsorption container 100 in a state in which a magnetic force is applied using the magnet 3 (see FIG. 7A).

The cap 110 and the plunger section 130 are moved in the direction away from the syringe section 120 when moving the magnetic bead 30 (or before moving the magnetic bead 30) to move the sample included in the adsorbent 10 from the plunger section 130 to the syringe section 120. The flow channel 2 that has been closed by the end section 134 communicates with the adsorbent 10 as a result of moving the plunger section 130.

The magnetic bead 30 moves upward within the flow channel 2 along with the movement of the magnet 3, and reaches the adsorbent 10 that includes the sample (see FIG. 7B).

### Step (D) That Causes Nucleic Acid to be Adsorbed on Magnetic Bead

In the step (D), the adsorption container 100 is shaken. The step (D) can be efficiently performed since the opening of the adsorption container 100 is sealed with the cap 110 so that the adsorbent 10 does not leak. The target nucleic acid is thus adsorbed on the surface of the magnetic bead 30 due to the effect of the chaotropic agent. In the step (D), a nucleic acid other than the target nucleic acid and proteins may be adsorbed on the surface of the magnetic bead 30.

The adsorption container 100 may be shaken using a known vortex shaker or the like, or may be shaken manually. The adsorption container 100 may be shaken while applying a magnetic field from the outside by utilizing the magnetic properties of the magnetic bead 30.

### Step (E) That Moves Magnetic Bead on Which Nucleic Acid is Adsorbed

In the step (E), the magnetic bead 30 is moved through the adsorbent 10, the first oil 20, the second oil 22, the third oil 24, the fourth oil 26, the first washing liquid 12, the second washing liquid 14, and the third washing liquid 16 while applying a magnetic force generated by the magnet 3 from the outside of the adsorption container 100, the washing container 200, and the elution container 300.

For example, a permanent magnet, an electromagnet, or the like may be used as the magnet 3. The magnet 3 may be moved manually, or may be moved using a mechanical device or the like. The magnetic bead 30 is moved within the flow channel 2 through the adsorption container 100, the washing container 200, and the elution container 300 while changing the relative position of the magnet 3 by utilizing the fact that the magnetic bead 30 is attracted by a magnetic force. The speed at which the magnetic bead 30 is passed through each washing liquid is not particularly limited. The magnetic bead 30 may be moved forward and backward within an identical washing liquid along the longitudinal direction of the flow channel 2. Note that a particle or the like other than the magnetic bead 30 may be moved within the tube by utilizing gravity or a potential difference, for example.

### Step (F) That Elutes Nucleic Acid

In the step (F), the nucleic acid is eluted from the magnetic bead 30 into the eluent droplet 36 within the elution container 300. In FIGS. 7A and 7B, the eluent 32 is present in the form of a plug within the thin part of the flow channel included in the elution container 300. The eluent droplet 36 moves upward within the elution container 300 (see FIGS. 8A and 8B) since the contents of the reaction container 400 expand as a result of heating the reaction container 400 while moving the magnetic bead 30. When the magnetic bead 30 has reached the eluent droplet 36 included in the elution container 300, the target nucleic acid adsorbed on the magnetic bead 30 is eluted into the eluent droplet 36 due to the effect of the eluent (see FIG. 8A).

Step (G) That Brings Droplet That Includes Nucleic Acid Into Contact with Reagent 34

In the step (G), the droplet 36 that includes the nucleic acid is brought into contact with the reagent 34 that is situated in the lowermost part of the reaction container 400. Specifically, the first oil 20 is pushed downward using the end section 134 of the plunger section 130 by moving the cap 110 downward. The eluent droplet 36 into which the target nucleic acid has been eluted thus enters the reaction container 400, and comes in contact with the reagent 34 that is situated in the lowermost part of the reaction container 400 in a state in which the magnetic bead 30 to which a magnetic force generated by the magnet 3 is applied is maintained at a predetermined position (see FIG. 8B). The reagent 34 that has come in contact with the droplet 36 is dissolved, and mixed with the target nucleic acid included in the eluent. PCR that utilizes thermal cycling is thus effected, for example.

### 4. PCR Device

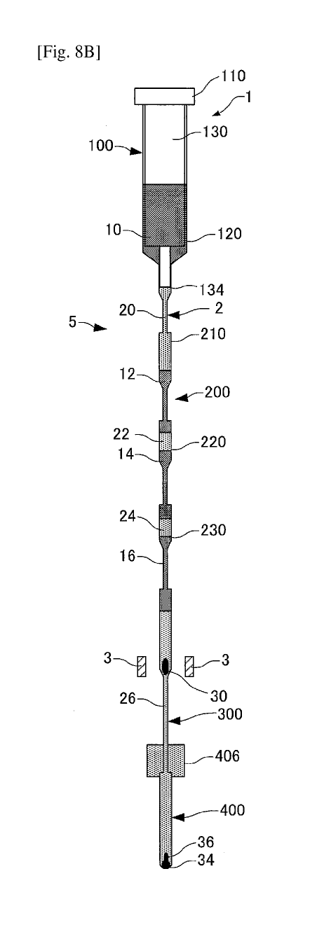

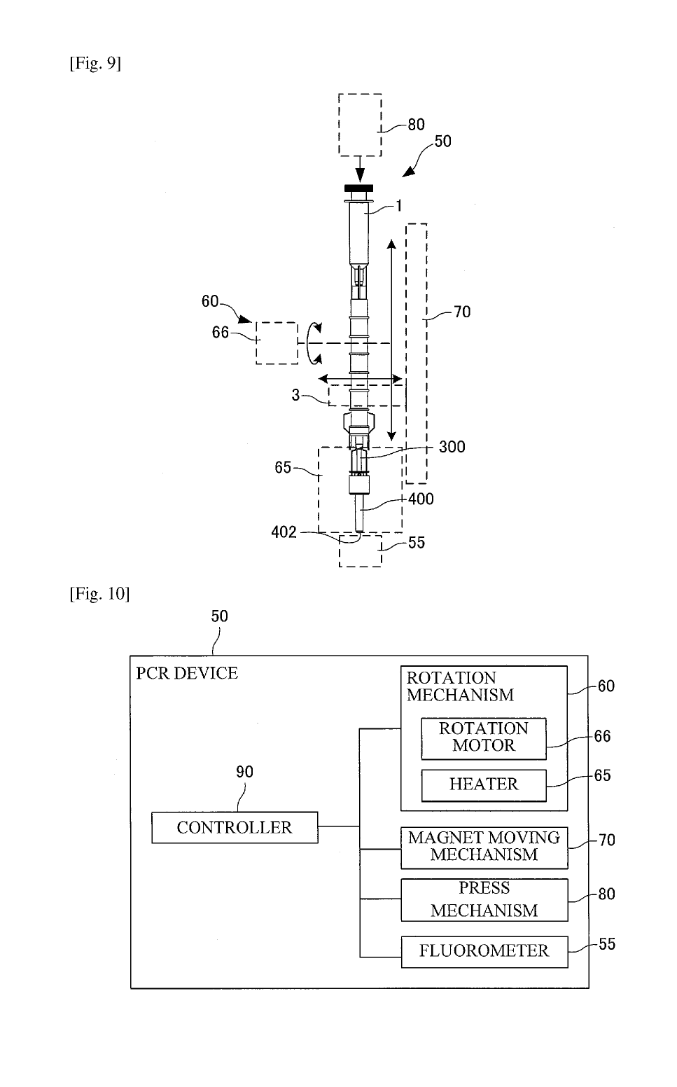

A PCR device 50 that implements a nucleic acid elution process and PCR using the container assembly 1 is described below with reference to FIGS. 9 and 10. FIG. 9 is a schematic configuration diagram illustrating the PCR device 50. FIG. 10 is a block diagram illustrating the PCR device 50.

The PCR device 50 includes a rotation mechanism 60, a magnet moving mechanism 70, a press mechanism 80, a fluorometer 55, and a controller 90.

### 4-1. Rotation Mechanism

The rotation mechanism 60 includes a rotation motor 66 and a heater 65, and rotates the container assembly 1 and the heater 65 by driving the rotation motor 66. When the container assembly 1 and the heater 65 are rotated (flipped upside down) by the rotation mechanism 60, the droplet that includes the target nucleic acid moves within the flow channel included in the reaction container 400, and subjected to thermal cycling.

The heater 65 includes a plurality of heaters (not illustrated in the drawings). For example, the heater 65 may include an elution heater, a high-temperature heater, and a low-temperature heater. The elution heater heats the eluent (that is present in the form of a plug) included in the container assembly 1 to promote elution of the target nucleic acid from the magnetic bead into the eluent. The high-temperature heater heats the upstream-side liquid within the flow channel included in the reaction container 400 to a temperature higher than that achieved by the low-temperature heater. The low-temperature heater heats the bottom 402 of the reaction container 400 (flow channel). It is possible to provide the liquid within the flow channel included in the reaction container 400 with a temperature gradient by utilizing the high-temperature heater and the low-temperature heater. The heater 65 is provided with a temperature controller, and can set the liquid within the container assembly 1 to a temperature suitable for the process according to an instruction from the controller 90.

The heater 65 has an opening that exposes the outer wall of the bottom 402 of the reaction container 400. The fluorometer 55 measures the brightness of the eluent droplet through the opening.

### 4-2. Magnet Moving Mechanism

The magnet moving mechanism 70 moves the magnet 3. The magnet moving mechanism 70 moves the magnetic bead within the container assembly 1 by moving the magnet 3 in a state in which the magnet 3 attracts the magnetic bead within the container assembly 1. The magnet moving mechanism 70 includes a pair of magnets 3, an elevating mechanism, and a swing mechanism.

The swing mechanism swings the pair of magnets 3 in the transverse direction (or the forward-backward direction) in FIG. 9. The pair of magnets 3 are disposed on either side of the container assembly 1 fitted to the PCR device 50 (see FIGS. 7A, 7B, 8A, and 8B). The distance between the magnetic bead and each magnet 3 can be reduced in the direction (transverse direction in FIG. 9) orthogonal to the flow channel of the container assembly 1. When the pair of magnets 3 are swung in the transverse direction (see the two-headed arrow), the magnetic bead within the container assembly 1 moves in the transverse direction along with the movement of the pair of magnets 3. The elevating mechanism moves the magnetic bead in the vertical direction in FIG. 9 by moving the magnet 3 in the vertical direction.

### 4-3. Press Mechanism

The press mechanism 80 presses the plunger section included in the container assembly 1. When the plunger section is pressed by the press mechanism 80, the droplet within the elution container 300 is discharged into the reaction container 400, and PCR is effected within the reaction container 400.

In FIG. 9, the press mechanism 80 is disposed above the container assembly 1 that is set to an upright state. Note that the press mechanism 80 may press the plunger section in the direction that is tilted by 45° with respect to the vertical direction, for example. This makes it possible to easily dispose the press mechanism 80 at a position at which the press mechanism 80 does not interfere with the magnet moving mechanism 70.

### 4-4. Fluorometer

The fluorometer 55 measures the brightness of the droplet within the reaction container 400. The fluorometer 55 is disposed at a position opposite to the bottom 402 of the reaction container 400. It is desirable that the fluorometer 55 be able to detect the brightness within a plurality of wavelength bands so that multiplex PCR can be implemented.

### 4-5. Controller

The controller 90 is a control section that controls the PCR device 50. The controller 90 includes a processor (e.g., CPU) and a storage device (e.g., ROM and RAM). Various programs and data are stored in the storage device. The storage device provides an area into which a program is loaded. Various processes are implemented by causing the processor to execute the program stored in the storage device.

For example, the controller 90 rotates the container assembly 1 to a predetermined rotation position by controlling the rotation motor 66. A rotation position sensor (not illustrated in the drawings) is provided to the rotation mechanism 60. The controller 90 drives and stops the rotation motor 66 corresponding to the detection results of the rotation position sensor.

The controller 90 heats the liquid within the container assembly 1 to a predetermined temperature by ON/OFF-controlling the heater 65.

The controller 90 moves the magnet 3 in the vertical direction by controlling the magnet moving mechanism 70, and swings the magnet 3 in the transverse direction in FIG. 9 corresponding to the detection results of a position sensor (not illustrated in the drawings).

The controller 90 measures the brightness of the droplet within the reaction container 400 by controlling the fluorometer 55. The measurement results are stored in a storage device (not illustrated in the drawings) included in the controller 90.

The container assembly 1 is fitted to the PCR device 50, and the steps (C) to (G) (see “3-2. Method for operating container assembly”) and PCR are effected.

### 5. Washing Flow Channel and Elution Flow Channel

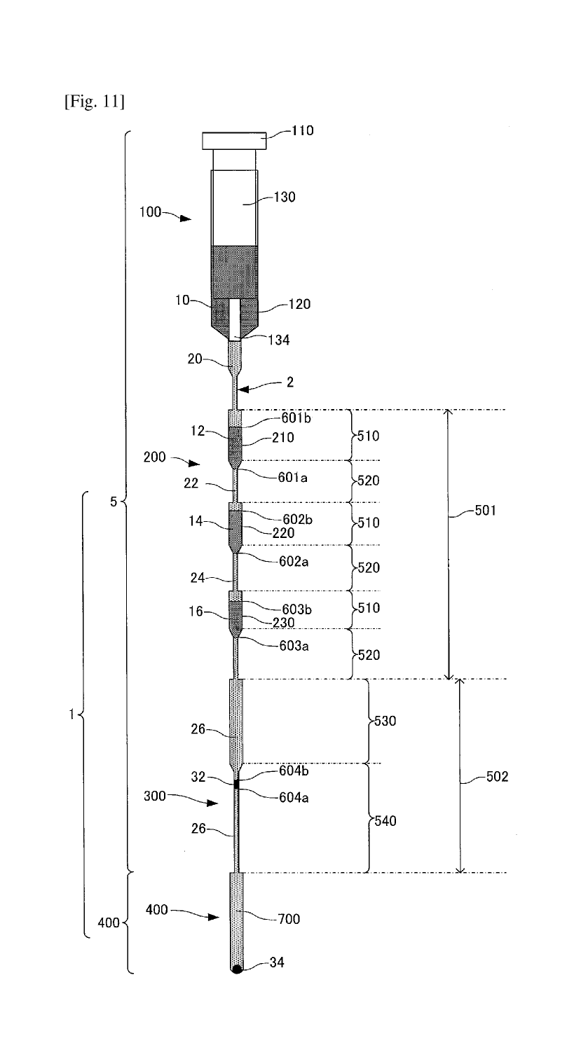

FIG. 11 is a schematic view illustrating the contents of the flow channel 2 when the container assembly 1 is set to the state illustrated in FIG. 1. As illustrated in FIG. 11, the container assembly 1 includes the adsorption container 100, the washing container 200, the elution container 300, and the reaction container 400. Specifically, the container assembly 1 includes the nucleic acid purification device 5 and the reaction container 400.

As illustrated in FIG. 11, the adsorbent 10, the first oil 20, the first washing liquid 12, the second oil 22, the second washing liquid 14, the third oil 24, the magnetic bead 30, the third oil 24, the third washing liquid 16, the fourth oil 26, the eluent 32, the fourth oil 26, and the reagent 34 are held within the flow channel 2 sequentially from the cap 110 to the reaction container 400.

The container assembly 1 includes a washing flow channel 501, and an elution flow channel 502 that communicates with the washing flow channel 501. The washing flow channel 501 is a flow channel formed by the washing container 200. The first oil 20, the first washing liquid 12, the second oil 22, the second washing liquid 14, the third oil 24, the magnetic bead 30, the third oil 24, the third washing liquid 16, the fourth oil 26, the eluent 32 and the fourth oil 26 are provided in the washing flow channel 501.

The washing flow channel 501 (that forms part of the flow channel 2 of the container assembly 1) is formed by the first washing container 210, the second washing container 220, and the third washing container 230. The first washing container 210, the second washing container 220, and the third washing container 230 have an identical basic structure. Each of the first washing container 210, the second washing container 220, and the third washing container 230 forms a first part 510 and a second part 520 of the washing flow channel 501.

Each of the washing flow channel 501 formed by the first washing container 210, the washing flow channel 501 formed by the second washing container 220, and the washing flow channel 501 formed by the third washing container 230 includes the first part 510 and the second part 520. The second part 520 is smaller than the first part 510 as to the cross-sectional area in a plane that is orthogonal to the direction in which the washing flow channel 501 extends (i.e., the direction in which the washing containers 210, 220, and 230 are arranged in the example illustrated in FIG. 11) (hereinafter may be referred to as “cross-sectional area”). Specifically, the first part 510 is thicker than the second part 520.

An interface 601a between the washing liquid 12 and the second oil 22 is situated within the second part 520 of the washing flow channel 501 formed by the first washing container 210. An interface 602a between the washing liquid 14 and the third oil 24 is situated within the second part 520 of the washing flow channel 501 formed by the second washing container 220. An interface 603a between the washing liquid 16 and the fourth oil 26 is situated within the second part 520 of the washing flow channel 501 formed by the third washing container 230.

The nucleic acid purification device 5 according to one embodiment of the invention is thus configured so that the interface 601a, the interface 602a, and the interface 603a between the washing liquid and the oil are situated within the second part 520 having a small cross-sectional area. Therefore, the area of each interface is smaller than that when each interface is situated within the first part 510 corresponding to the cross-sectional area in a plane that is orthogonal to the direction in which the washing flow channel 501 extends.

The elution flow channel 502 is a flow channel formed by the elution container 300. The fourth oil 26, the eluent 32, and the fourth oil 26 are sequentially provided in the elution flow channel 502. The elution flow channel 502 includes a third part 530 and a fourth part 540. The fourth part 540 is smaller than the third part 530 as to the cross-sectional area in a plane that is orthogonal to the direction in which the elution flow channel 502 extends. Specifically, the third part 530 is thicker than the fourth part 540. An interface 604a between the eluent 32 and the fourth oil 26 is situated within the fourth part 540.

The nucleic acid purification device 5 according to one embodiment of the invention is thus configured so that the interface 601a, the interface 602a, the interface 603a, and the interface 604a between the washing liquid or the eluent and the oil are situated within the second part 520 and the fourth part 540 having a small cross-sectional area. Therefore, the area of each interface is smaller than that when each interface is situated within the first part 510 or the third part 530 corresponding to the cross-sectional area in a plane that is orthogonal to the direction in which the washing flow channel 501 and the elution flow channel 502 extend.

When the area of the interface is small, the interfacial tension at the interface is predominant over the inertial force applied to the fluid. Therefore, a situation rarely occurs in which the interface is deformed (fluctuates) or moved due to the pressure applied to the flow channel or the inertial force that occurs due to external force, for example. This makes it possible to stably maintain the positions of the washing liquid, the eluent, and the fluids that are immiscible therewith in the direction in which the flow channel extends.

Note that the positions of the interface 601a, the interface 602a, and the interface 603a within the second part 520 in the direction in which the washing flow channel 501 extends are not particularly limited. The positions of the interface 601a, the interface 602a, and the interface 603a may be appropriately set taking account of the interval between adjacent plugs, the volume of the washing liquid, and the like. The position of the interface 604a within the fourth part 540 in the direction in which the elution flow channel 502 extends is not particularly limited. The position of the interface 604a may be appropriately set taking account of the operation of the nucleic acid purification device 5, the volume of the eluent, and the like.

The nucleic acid purification device 5 according to one embodiment of the invention is configured so that the first part 510 and the second part 520 of the washing flow channel 501 have an approximately cylindrical shape, and have a diameter of 2 mm and 1 mm, respectively. Note that the shape and the cross-sectional area of the first part 510 and the second part 520 of the washing flow channel 501 may be appropriately changed as described below.

The area (i.e., the cross-sectional area in a plane that is orthogonal to the direction in which the washing flow channel 501 extends) of the interface by which the interfacial tension at the interface is predominant over the inertial force applied to the fluid is smaller than about 3.2 mm². Specifically, the cross-sectional area of the second part 520 is preferably set to about 3.2 mm² or less (i.e., the diameter of the second part 520 is preferably set to about 2.0 mm or less when the second part 520 has a cylindrical shape). If the cross-sectional area of the second part 520 is 0.01 mm² or less (i.e., the diameter of the second part 520 is 0.3 mm or less when the second part 520 has a cylindrical shape), the interfacial tension at the interface is predominant over the inertial force applied to the fluid, but it may be necessary to reduce the volume of the washing liquid, or the resistance when the fluid flows may increase. The cross-sectional area of the second part 520 of the washing flow channel 501 may be set based on the above indices, for example.

The cross-sectional area of the first part 510 is not particularly limited as long as the cross-sectional area of the first part 510 is larger than that of the second part 520, and an additional interface (interface 601b, interface 602b, and interface 603b (described later)) of the washing liquid can be formed within the first part 510 so as to maintain the washing liquid in the shape of a plug. For example, the cross-sectional area of the first part 510 is preferably set to about 3.2 mm² or more (i.e., the diameter of the first part 510 is preferably set to about 2.0 mm or more when the first part 510 has a cylindrical shape). It is possible to easily increase the volume of the washing liquid without increasing the length of the nucleic acid purification device 5 by increasing the cross-sectional area of the first part 510. If the cross-sectional area of the first part 510 is set to about 20 mm² or more (i.e., the diameter of the first part 510 is set to about 5 mm or more when the first part 510 has a cylindrical shape), it may be difficult to maintain the washing liquid in the shape of a plug. The cross-sectional area of the first part 510 of the washing flow channel 501 may be set based on the above indices, for example.

The length of the first part 510 and the length of the second part 520 in the direction in which the washing flow channel 501 extends are not particularly limited, and may be appropriately designed.

The nucleic acid purification device 5 according to one embodiment of the invention is configured so that the washing flow channel 501 includes three first parts 510 and three second parts 520. Note that the number of second parts 520 and the number of first parts 510 are not particularly limited (i.e., may be 1, 2, or 4 or more) as long as an interface can be provided within the second part 520. When a plurality of first parts 510 and a plurality of second parts 520 are provided (see FIG. 11), the first parts 510 and the second parts 520 may be alternately provided in the direction in which the washing flow channel 501 extends. In this case, it is possible to provide the washing liquid within each second part 520 of the washing flow channel 501 in a stable manner, and easily wash the nucleic acid (substance-binding solid-phase carrier) with the washing liquid two or more times. This makes it possible to more efficiently wash the nucleic acid (substance-binding solid-phase carrier).

In the example illustrated in FIG. 11, a plurality of first parts 510 and a plurality of second parts 520 are provided, and the washing flow channel 501 is configured so that the first part 510 is provided adjacent to the adsorption container 100, and the second part 520 is provided adjacent to the elution container 300. Note that the arrangement of the first parts 510 and the second parts 520 may be arbitrarily changed corresponding to the design of each container. For example, the second part 520 may be provided adjacent to the adsorption container 100, and the first part 510 may be provided adjacent to the elution container 300, or the first part 510 may be provided adjacent to the adsorption container 100 and the elution container 300, or the second part 520 may be provided adjacent to the adsorption container 100 and the elution container 300.

The nucleic acid purification device 5 according to one embodiment of the invention is configured so that the elution flow channel 502 includes one third part 530 and one fourth part 540. Note that the number of third parts 530 and the number of fourth parts 540 are not particularly limited (i.e., may be 2 or more) as long as an interface can be provided within the fourth part 540. When a plurality of third parts 530 and a plurality of fourth parts 540 are provided (not illustrated in the drawings), the third parts 530 and the fourth parts 540 may be alternately provided in the direction in which the elution flow channel 502 extends.

In the example illustrated in FIG. 11, the elution flow channel 502 is configured so that the third part 530 is provided adjacent to the washing container 230, and the fourth part 540 is provided adjacent to the reaction container 400. Note that the arrangement of the third part 530 and the fourth part 540 may be arbitrarily changed corresponding to the design of each container. For example, the fourth part 540 may be provided adjacent to the washing container 230, and the third part 530 may be provided adjacent to the reaction container 400, or the third part 530 may be provided adjacent to the washing container 230 and the reaction container 400, or the fourth part 540 may be provided adjacent to the washing container 230 and the reaction container 400.

The dimensions of the third part 530 and the fourth part 540 of the elution flow channel 502 may be designed in the same manner as described above in connection with the first part 510 and the second part 520 of the washing flow channel 501, and may be appropriately changed as described below.

The cross-sectional area of the fourth part 540 is preferably set to about 3.2 mm² or less (i.e., the diameter of the fourth part 540 is preferably set to about 2.0 mm or less when the fourth part 540 has a cylindrical shape). If the cross-sectional area of the fourth part 540 is 0.01 mm² or less (i.e., the diameter of the fourth part 540 is 0.3 mm or less when the fourth part 540 has a cylindrical shape), the interfacial tension at the interface is predominant over the inertial force applied to the fluid, but it may be necessary to reduce the volume of the eluent 32, or the resistance when the fluid flows may increase. Moreover, the length of the eluent 32 in the direction in which the elution flow channel 502 extends may increase to a large extent. The cross-sectional area of the fourth part 540 of the elution flow channel 502 may be set based on the above indices, for example.

The cross-sectional area of the third part 530 is not particularly limited as long as the cross-sectional area of the third part 530 is larger than that of the fourth part 540, and a droplet of the eluent 32 can be formed within the fourth oil 26 when the eluent 32 has moved to the third part 530. For example, the cross-sectional area of the third part 530 is preferably set to about 3.2 mm² or more (i.e., the diameter of the third part 530 is preferably set to about 2.0 mm or more when the third part 530 has a cylindrical shape). Note that the cross-sectional area of the third part 530 is determined taking account of the volume of the eluent 32. The cross-sectional area of the third part 530 of the elution flow channel 502 may be set based on the above indices, for example.

The length of the third part 530 and the length of the fourth part 540 in the direction in which the elution flow channel 502 extends are not particularly limited, and may be appropriately designed.

The nucleic acid purification device 5 according to one embodiment of the invention is configured so that the interface 601a, the interface 602a, and the interface 603a of the washing liquid 12, the washing liquid 14, and the washing liquid 16 situated on the side of the elution container 300 are situated within the second part 520, and the interface 601b, the interface 602b, and the interface 603b of the washing liquid 12, the washing liquid 14, and the washing liquid 16 situated on the side of the adsorption container 100 are situated within the first part 510. When only one of the interfaces of the washing liquid (plug) is situated within the second part 520, it is possible to immobilize the plug in a sufficiently stable manner.

The nucleic acid purification device 5 is configured so that the interface between the washing liquid and an oil is situated within the second part 520 having a small cross-sectional area, and the interface between the washing liquid and another oil is situated within the first part 510 having a large cross-sectional area. This makes it possible to stably maintain the position of the washing liquid in the direction in which the flow channel extends, and increase the volume of the washing liquid without increasing the length of the device in the direction in which the flow channel extends. This makes it possible to more efficiently wash the target substance.

Note that the interface 601b, the interface 602b, and the interface 603b situated on the side of the adsorption container 100 may optionally be provided within the second part 520. In this case, the positions of the interface 601b, the interface 602b, and the interface 603b within the second part 520 in the direction in which the washing flow channel 501 extends are not particularly limited. The positions of the interface 601b, the interface 602b, and the interface 603b may be appropriately set taking account of the interval between adjacent plugs, the volume of the washing liquid, and the like.

The nucleic acid purification device 5 according to one embodiment of the invention is configured so that the interface 604a of the eluent 32 situated on the side of the reaction container 400 is situated within the fourth part 540, and the interface 604b of the eluent 32 situated on the side of the washing container 200 is also situated within the fourth part 540. It is possible to more reliably immobilize the eluent 32 (plug) by providing each interface of the eluent 32 (plug) within the fourth part 540. Note that the interface 604b situated on the side of the washing container 200 may optionally be provided within the third part 530.

### 6. Cartridge

A cartridge (container assembly 1) according to one embodiment of the invention includes the nucleic acid purification device 5 and the reaction container 400 (see “2-4. Reaction container”).

The reaction container 400 forms a reaction chamber 700 that communicates with the elution flow channel 502. As illustrated in FIG. 11, the reaction chamber 700 holds the fourth oil 26 and the reagent 34 in a state in which the container assembly 1 has been assembled. The fourth oil 26 within the reaction chamber 700 is continuous with the fourth oil 26 within the elution flow channel 502. A PCR (nucleic acid amplification reaction) thermal cycling reaction is effected within the reaction chamber 700.

Since the cartridge according to one embodiment of the invention is configured so that the positions of the washing liquid, the eluent 32, and the fluids (oils) that are immiscible therewith in the direction in which the flow channel extends can be maintained in a stable manner, it is possible to easily purify the nucleic acid, and efficiently effect the nucleic acid amplification reaction while reducing time.

The invention is not limited to the above embodiments. Various modifications and variations may be made of the above embodiments without departing from the scope of the invention. For example, the invention includes various other configurations that are substantially the same as the configurations described in connection with the above embodiments (e.g., a configuration having the same function, method, and results, or a configuration having the same objective and results). Although the above embodiments have been described taking an example in which the adsorption flow channel, the washing flow channel, and the elution flow channel are combined, the scope of the invention also includes a substance purification device that includes two or more washing flow channels. The invention also includes a configuration in which an unsubstantial element described in connection with the above embodiments is replaced by another element. The invention also includes a configuration having the same effects as those of the configurations described in connection with the above embodiments, or a configuration capable of achieving the same objective as that of the configurations described in connection with the above embodiments. The invention further includes a configuration in which a known technique is added to the configurations described in connection with the above embodiments.

1. A substance purification device comprising:
a washing flow channel; and
an elution flow channel that communicates with the washing flow channel,
the washing flow channel including a first part, and a second part that is smaller than the first part as to a cross-sectional area in a plane that is orthogonal to a direction in which the washing flow channel extends, an interface between a washing liquid and a fluid that is immiscible with the washing liquid being situated within the second part,
the elution flow channel including a third part, and a fourth part that is smaller than the third part as to a cross-sectional area in a plane that is orthogonal to a direction in which the elution flow channel extends, an interface between an eluent and a fluid that is immiscible with the eluent being situated within the fourth part,
the washing liquid being a liquid with which a substance-binding solid-phase carrier on which a substance is adsorbed is washed, and
the eluent being a liquid with which the substance is eluted from the substance-binding solid-phase carrier.

2. The substance purification device as defined in claim 1,
the washing flow channel including a plurality of the first parts and a plurality of the second parts, and
the plurality of first parts and the plurality of second parts being alternately provided in the direction in which the washing flow channel extends.

3. The substance purification device as defined in claim 1,
an interface between the washing liquid and the fluid that is immiscible with the washing liquid being situated within the first part.

4. The substance purification device as defined in claim 1,
wherein the cross-sectional area of the second part in a plane that is orthogonal to the direction in which the washing flow channel extends, and the cross-sectional area of the fourth part in a plane that is orthogonal to the direction in which the elution flow channel extends are less than 3.2 mm2.

5. A cartridge comprising:
the substance purification device as defined in claim 1; and
a reaction container that forms a reaction chamber that communicates with the elution flow channel,
the substance being a nucleic acid, and
the reaction chamber holding a fluid that is immiscible with the eluent, a nucleic acid amplification reaction being effected within the reaction chamber.

6. A substance purification device comprising:
a first washing flow channel; and
a second washing flow channel that communicates with the first washing flow channel,
the first washing flow channel including a first part, and a second part that is smaller than the first part as to a cross-sectional area in a plane that is orthogonal to a direction in which the first washing flow channel extends, an interface between a first washing liquid and a fluid that is immiscible with the first washing liquid being situated within the second part,
the second washing flow channel including a third part, and a fourth part that is smaller than the third part as to a cross-sectional area in a plane that is orthogonal to a direction in which the second washing flow channel extends, an interface between a second washing liquid and a fluid that is immiscible with the second washing liquid being situated within the fourth part, and
the first washing liquid and the second washing liquid being a liquid with which a substance-binding solid-phase carrier on which a substance is adsorbed is washed.

7. The substance purification device as defined in claim 6,
wherein the cross-sectional area of the second part in a plane that is orthogonal to the direction in which the first washing flow channel extends, and the cross-sectional area of the fourth part in a plane that is orthogonal to the direction in which the second washing flow channel extends are less than 3.2 mm2.

8. A cartridge comprising:
the substance purification device as defined in claim 6; and
a reaction container that forms a reaction chamber that communicates with the first washing flow channel or the second washing flow channel,
the substance being a nucleic acid, and
a nucleic acid amplification reaction being effected within the reaction chamber.
